(19) United States
(12) Patent Application Publication
(10) Pub. No.: US 2010/0030794 A1
(43) Pub. Date: Feb. 4, 2010

(54) SYSTEM AND METHOD OF UPDATING PHONE NUMBER LISTS

(75) Inventor: Philip Andrew Ljubicich, Lake Forest Park, WA (US)

Correspondence Address: MARGER JOHNSON & MCCOLLOM, P.C., 210 SW MORRISON STREET, SUITE 400, PORTLAND, OR, 97204, US

(73) Assignee: Melissa Data Corp., Rancho Santa Margarita, CA (US)

(21) Appl. No.: 12/510,747

(22) Filed: Jul. 28, 2009

Related U.S. Application Data
(60) Provisional application No. 61/085,291, filed on Jul. 31, 2008.

(51) Int. Cl. G06F 17/00

(52) U.S. Cl. 707/100; 379/201.01; 707/E17.005

(57) ABSTRACT

A method including creating a first set of records associated with a phone number from a database in response to a reference date; creating a second set of records associated with the phone number from the database in response to the first set of records; comparing the first set of records to the second set of records; and updating a status of the phone number in a do-not-call database in response to the comparing of the first set of records to the second set of records.

### CROSS-REFERENCE TO RELATED APPLICATIONS

This application claims priority under 35 U.S.C. §119(e) from U.S. Provisional Application Ser. No. 61/085,291, filed on Jul. 31, 2008, the contents of which are herein incorporated by reference in their entirety.

### BACKGROUND

This disclosure relates to updating phone number lists and, in particular, to updating a do not call phone number list.

With telemarketing legislation passed early in the decade, both the federal government and telemarketers are required to keep Do Not Call (DNC) lists. These are lists of phone numbers that telemarketers are not allowed to solicit.

A National Do Not Call (NDNC) list is handled by the federal government. All telemarketers are required to comply with this list when doing telemarketing to consumers when they do not have an existing business relationship with the consumer.

Each telemarketer is also responsible for keeping an Internal Do Not Call (IDNC) list. This is a list of consumers they have contacted who have instructed them to remove them from their call list. The telemarketer can be prohibited from telemarketing to that consumer at that phone number for several years from the date they are informed that they do not want to be called.

For companies that do large volumes of telemarketing, the IDNC list can grow quite large (hundreds of thousands or millions of blocked phone numbers). Over time, many of these numbers are reassigned. Unless the telemarketer can discover which ones have been reassigned the telemarketer needs to avoid telemarketing to all the phone numbers on their list to avoid significant legal penalties.

To further complicate this, the telemarketer usually does not have definitive ownership information for a given phone number. Often, all of the information available to the telemarketer is a 10-digit phone number and a date that the telemarketer was told to add that number to their IDNC list.

As a result, telemarketers are avoiding calling millions of valid prospects simply because they are unable to demonstrate that the phone number is now owned by a new consumer.

### BRIEF DESCRIPTION OF THE DRAWINGS

FIG. 1 is a flowchart illustrating a technique of updating a phone number list according to an embodiment.

FIG. 2 is a flowchart illustrating an example of creating a first set of records according to an embodiment.

FIG. 3 is a flowchart illustrating an example of creating a second set of records according to an embodiment.

FIG. 4 is a table including an example of a listing database according to an embodiment.

FIG. 5 is a table including an example of a first set of records according to an embodiment.

FIG. 6 is a table including an example of a second set of records according to an embodiment.

FIG. 7 is a table including an example of another first set of records according to an embodiment.

FIG. 8 is a table including an example of another second set of records according to an embodiment.

FIG. 9 is a block diagram of a system according to an embodiment.

### DETAILED DESCRIPTION

Embodiments will be described in reference to the drawings. In particular, embodiments will be described where a phone list such as a Do Not Call (DNC) list can be updated. In an embodiment, telemarketers can purge a National DNC (NDNC) list, an Internal DNC (IDNC) list, or the like of numbers that are no longer possessed by the consumer that originally stated a preference to have their number blocked from telemarketing.

In addition, in an embodiment, the technique can use two pieces of information provided by the list owner: the 10 digit phone number and the date on which a consumer most recently requested that the phone number be added to the NDNC or IDNC call list. In particular, many telemarketers do not keep full contact information related to phone numbers on their IDNC list. Thus, in an embodiment, the only pieces of information available can be the phone number and the date.

Establishing that a phone number has been disconnected can be difficult with some or all of the commercially available data sets in the US. However, as will be described in further detail below, in an embodiment, a determination can be made whether a phone number has been disconnected, reconnected, transferred, or the like such that a determination with increased reliability can be made on whether to remove the phone number from a DNC list.

One would assume that you could demonstrate that a phone number was disconnected by a simple examination of White Page or Directory Assistance Data (DA Data). Most land line phone numbers in the US are published in the White Pages and through Directory Assistance Data by the carriers that provision the phone number. It would appear that when a phone number disappears from published listing set, that the phone number can safely be assumed to have gone out of service and that the phone number can be deleted from the NDNC or IDNC list.

However, there are several reasons why numbers can disappear from the published DA Data. For example, the phone number can change from a Published status to a Non Published status. In another example, the phone number may have been ported through Local Number Portability from a carrier that reports their published listing information to one that does not report their listing. Many Voice Over Internet Protocol (VOIP) carriers do not report white page listings. In another example, numbers may temporarily disappear from published service due to non-pay issues with the provisioning Telco, but reappear to the same owner a short period of time later.

Because of these problems, the presence of a phone number in DA Data can be relied on to positively affirm an owner, but the absence of a phone number from DA Data can not be relied on to conclude that the ownership of a phone number has terminated. That is, a disappearance of a phone number from such data sets may not equate with a termination of ownership of the phone number.

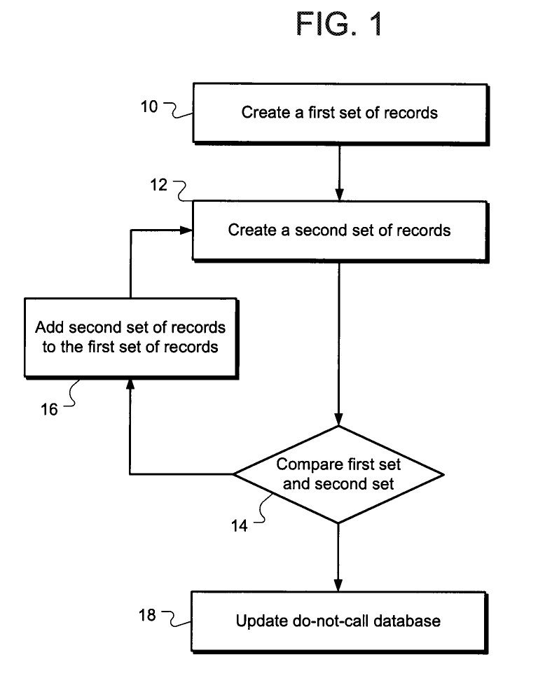

FIG. 1 is a flowchart illustrating a technique of updating a phone number list according to an embodiment. In 10, a first set of records associated with a phone number from a database can be created in response to a reference date. In an embodiment, the database can be a DA Data database. For example, the database can include phone numbers, owners, effective dates, expirations dates, and the like. The database can also include other data associated with the phone numbers.

In a particular embodiment, the database can be a Historical Listings Database (HLD). The HLD can be created from a national set of DA Data along with a compilation of all of the daily adds and deletes to that database over a number of years. These changes were compiled into a set of DA Data records, augmented with two dates: an effective date and an expiration date. That is, for a given phone number, the database can include dates representing when that phone number was associated with a particular owner and when the phone number may no longer be associated with the owner. For example, as described above, an owner may not be current on payments to a service provider. The service provider may disconnect the service. The database can correspondingly indicate that the service has expired. However, after payment, the service may be reconnected. The reconnected service may result in an additional record in the database associated with the same phone number with a new effective date, i.e. the date the service was restored.

These augmented records can include some or all of the DA Data fields such as a listing name, phone number, and full or partial address information, or the like. By examining the adds and deletes, HLD records can be constructed by aggregating the add and delete records to create blocks of continuous ownership (date ranges) for a given telephone number. Such continuous date ranges can be grouped by common name, address, information, or other identifying information present in the DA Data, additional data, or the like.

A technique for constructing the HLD records may be implemented in accordance with the disclosure in Patent Application Publication No. US 2006/0112133 A1, which is hereby incorporated by reference.

From this database, two sets of records can be created. As describe above, a first set can be created in 10 that represent a continuum of ownership for a given phone number. A second set can be created in 12 representing another, potentially distinct continuum of ownership during a subsequent period for the same phone number. If a comparison between the first and second sets in 14 indicates that the owner is substantially different between the two sets, the Do Not Call database can be updated in 18. If the owner is not substantially different, the first and second sets can be combined in 16 to form a new first set. A new second set can be created in 12 in response to the new first set created in 16. In an embodiment, a second set can be created representing another continuum of ownership of a phone number during a period after the date range of the new first set.

As described above, in 16, the first and second sets can be combined if the ownership is not substantially different. The resulting new first set of records can represent records for a substantially continuous time for a common owner. That is, the ownership can be assumed to be the same even if the owners are not identical. In addition, even though a second set was created in 12 that had a date range that did not overlap the date range of the first set, the sets can be combined into a new aggregate set with an associated new date range. That is, the telephone number likely did not change owners over this new date range and thus, should not yet be removed from the DNC list.

The comparison in 14 can be accomplished by a variety of techniques. For example, the comparison can include comparing one or more names associated with the records of the first set with one or more names associated with the records of the second set. In another example, the comparison can include comparing names, addresses, or other personally identifying data.

A match from the comparison in 14 can, but need not include an exact match. For example, in matching a name, Thomas Jones can be a match with Tom Jones. In another example, the first set may include multiple names. A match can include matching one name of the second set to any name of the first set, or vice versa.

In an embodiment, a degree of similarity can be used to determine if there is a material similarity between the records of the first set and the second set. That is, a comparison can, but need not result in either matching or not matching. The comparison can result in a fuzzy logic output with a degree of similarity. A threshold can be selected for the degree of similarity for making the determination of a match.

If a match is found between a name of a record of the first set and a name of a record of the second set, as described above, the second set can be added to the records of the first set. If a match is not found between a name of a record of the first set and a name of a record of the second set the phone number can be removed from the DNC list in 18.

In an embodiment, after one or more iterations of combining the second set into the first set in 16, the new second set created in 12 can be the empty set. That is, no records remain in the database to be added to a new second set. In this circumstance, the phone number can be left in the DNC list. That is, an assumption can be made that the phone number is still valid and associated with an owner in the first set, even if the date range of the first set expires before the current date. In another embodiment, if the date range of the first set extends beyond the current date, the phone number can be left in the DNC list.

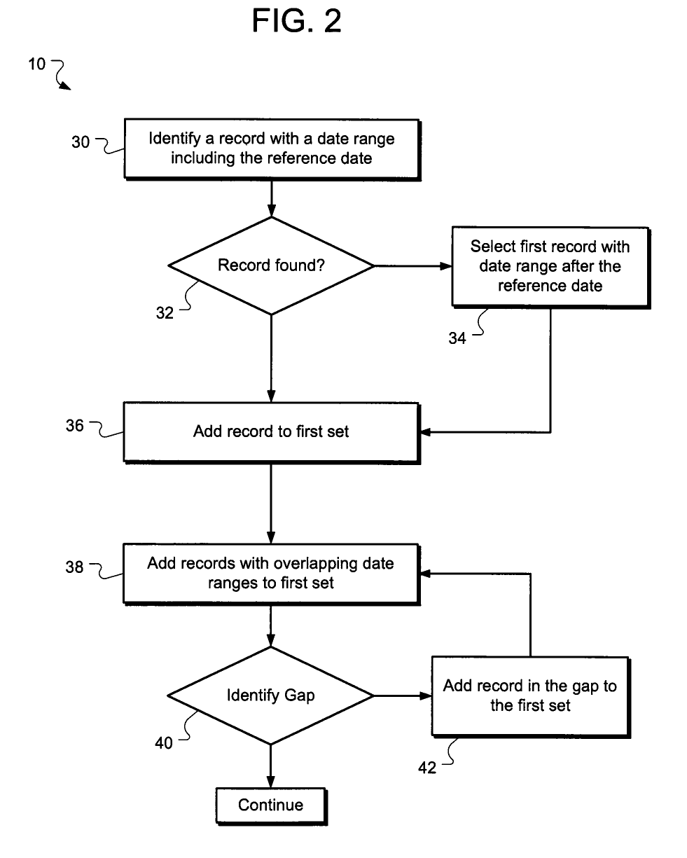

FIG. 2 is a flowchart illustrating an example of creating a first set of records according to an embodiment. In this embodiment, a reference date is used to identify a record in the database. The reference date can be a date on which the phone number was added to the DNC list.

The reference date can be used in 30 to identify a record with a date range including the reference date. For example, the reference date can fall between an effective date and an expiration date of the record. If a record is found in 32, the record can be added to the first set in 36. However, if the record is not found, a record of the database having a date range after the reference date can be identified and added to the first set in 36.

At this point, only one record exists in the first set. However, in 38, other records with date ranges overlapping a date range of the first record in the first set can be added to the first set. In an embodiment, any and all records that have date ranges overlapping the date range can be added. However, the additional records in the first set may include date ranges that overlap, but are not the same as the date range of the first identified record. In 38, more additional records can be added that have date ranges that overlap any date range of any record of the first set. This can be repeated until there are no other records in the database that have date ranges that overlap a date range of any record in the first set that is not already in the first set. Thus, at this time, the first set can represent a continuum of overlapping ownership records.

In an embodiment, gap can be identified after an end of the date range of the first set in 40. For example, a 30 day gap can be identified by searching for any records that have a date range that begins within the gap. For example, if a record with an effective date that is within the 30 days after the end of the date range of the first set exists, then there is not a 30 day gap. Such a record can be added to the first set in 42 and the process of adding records with overlapping date ranges can be repeated in 38. Alternatively, if there is a gap, the processing can continue.

In particular, for a given phone number, changes can occur in the listing. For example, a person's name may change. Thus two records for the same person may have different names. Accordingly, the record with an apparently distinct owner can be combined with the first set. Thus, the first set can further represent a continuous ownership.

Although 30 days have been given as an example of the gap, other time periods can be used. For example, 15 days, 60 days, a number of days remaining in the month, a number of days including a complete calendar month, or the like can be used.

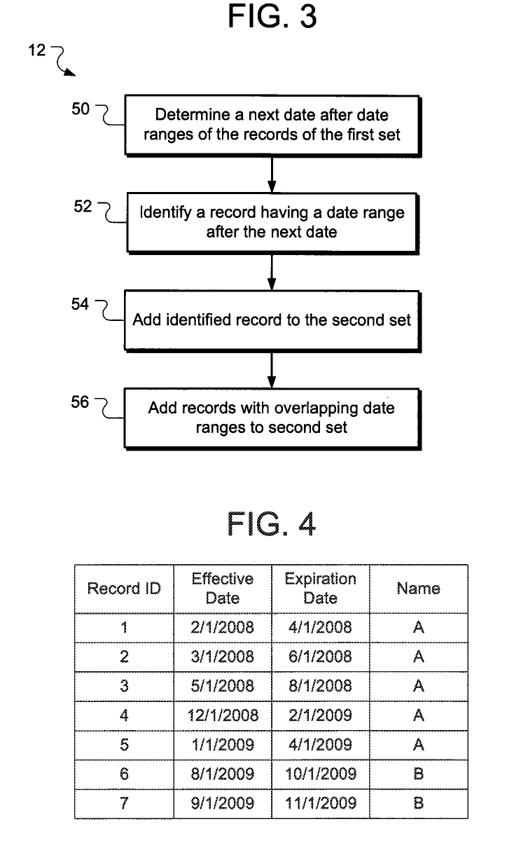

FIG. 3 is a flowchart illustrating an example of creating a second set of records according to an embodiment. As described above, the first set can include one or more records with associated date ranges. A next date after the date ranges of the first set can be determined in 50. In an embodiment, the next date can be 90 days after a last date of the date ranges of the records of the first set. However, in other embodiments, different lengths of time can be used to determine the next date.

In 52 a record having a date range including or after the next date. This record can be added to the second set in 54. In 56, similar to the first set, records with date ranges overlapping the date range of the first record in the second set can be added to the second set. The process can be repeated until all records with date ranges overlapping a date range of any record in the second set is added to the second set. Again, similar to the first set, a second set with a continuum of ownership has been created.

Referring back to FIG. 1, the first set and the second set can be compared in 14 and if there is a match, the sets can be combined in 16. If there is some match, it is likely that there is some common ownership between the first set and the second set. Thus, the combination of the first and second set creates an aggregate set with a new date range for ownership. Although the combined data range may not be continuous, the date range can be interpreted as having continuous ownership. Moreover, in an embodiment, once the records have been added to the first set, another gap an be identified after an end of the new first set, similar to the gap described above with reference to 40 of FIG. 2.

The creation of the second set can be repeated using the new date range to determine the next date in 50 of FIG. 3. Thus, a second set with a different date range can be created having a potential to be associated with a different owner. This technique can be repeated until there is no match or there are no remaining records after the date range of the first set, as described above.

FIG. 4 is a table including an example of a listing database according to an embodiment. The table represents records of a database associated with a single phone number. The phone number has been omitted from the table for clarity. In particular, there are multiple records, some with overlapping date ranges, some with different names, and the like.

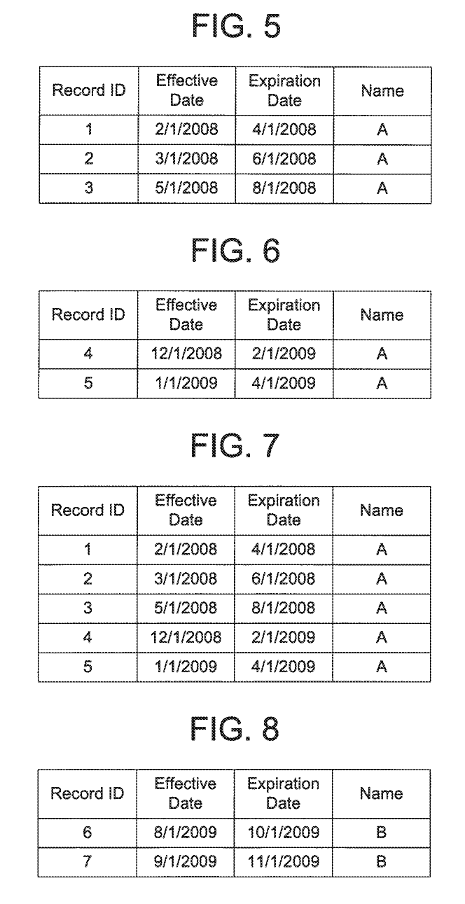

FIG. 5 is a table including an example of a first set of records according to an embodiment. Referring to FIGS. 4 and 5, assume that a reference date of 1/1/2008 is selected. No date range of any record includes 1/1/2008. Accordingly, as described above with reference to FIG. 2, the record with the next date range can be selected to be the first record of the first set. Thus, record 1 is added to the first set of FIG. 5. Alternatively, a reference date of 3/1/2008 could have been used. Record 1 overlaps the reference date, thus record 1 is added to the first set of FIG. 5.

In addition, as described above, records with date ranges overlapping the first record in the first set are added to the first set. Thus, record 2 which has a date range overlapping record 1 is added to the first set of FIG. 5. Record 3 does not overlap the date range of record 1, the first record; however, record 3 does overlap the date range of record 2. Since record 2 is in the first set, record 3 is added to the first set. The remaining records do not have date ranges that overlap any date range of records of the first set. Thus, the first set of FIG. 5 is an initial first set.

FIG. 6 is a table including an example of a second set of records according to an embodiment. Referring to FIGS. 4-6, the date ranges of the first set of FIG. 5 extend from 2/1/2008 to 8/1/2008. Record 4 has a date range that begins after 8/1/2008, namely 12/1/2008. Moreover, the date is greater than 90 days from the latest date of the records of the first set of FIG. 5. Thus, record 4 is identified and added to the second set of FIG. 6 as an initial record.

Records with overlapping date ranges are again added. In this example, record 5 has a date range overlapping the date range of record 4. Thus, record 5 is added to the second set. No other records have date ranges that overlap any date range of the records of the second set of FIG. 6. Thus, the second set of FIG. 6 is complete.

FIG. 7 is a table including an example of another first set of records according to an embodiment. Referring to FIGS. 5-7, as described above, the first set and the second set are compared together. In this example, records of both the first set of FIG. 5 and the second set of FIG. 6 are associated with name A. Thus, there is a match between the sets and the second set of FIG. 6 is added to the first set of FIG. 5. The table of FIG. 7 represents the new first set.

FIG. 8 is a table including an example of another second set of records according to an embodiment. Referring to FIGS. 4, 7 and 8, as described above, a new second set is created after a new first set, namely the first set of FIG. 7, is created. The latest date of the first set of FIG. 7 is 4/1/2009. Record 6 has a date range that is after the latest date of the first set of FIG. 7. Thus, record 6 becomes the first record of the second set of FIG. 8. Record 7 is also added as record 7 has a date range that overlaps the date range of record 6. Thus, FIG. 8 represents another complete second set.

In this example the second set of FIG. 8 is associated with a different name, namely name B. Assuming that name B is substantially different from name A, a determination can be made that the ownership of the phone number has changed. Thus, the phone number can be removed from the DNC list.

However, in another embodiment, assuming that name B is not substantially different, the second set of FIG. 8 can be added into the first set of FIG. 7 and the process repeated. In this example, there are no remaining records, thus the next second set is an empty set. As a result, the phone number is left in the DNC list, as described above. However, as the records of FIG. 4-8 are only an example, other records could have been present with different names, date ranges, or the like and the processing can continue. Moreover, although a particular sequence of combining a second set with a first set has been described, in an embodiment, the first identified second set can be substantially different from the first set without the process of combining the sets together.

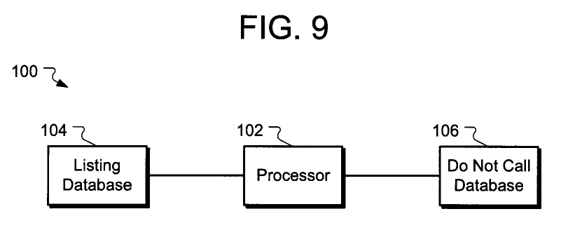

FIG. 9 is a block diagram of a system according to an embodiment. In this embodiment, the system 100 includes a processor 102. The processor 102 is coupled to a listing database 104 and a DNC database 106. The listing database 104 can include the various records associated with phone numbers described above. The processor 102 can be configured to perform the techniques described above. For example, the processor 102 can be configure to access the records in the listing database 104 to create the first and second sets as described above. The processor 102 can be configured to update the DNC database 106 in response.

The processor 102 can be any variety of devices, systems, or the like. For example, the processor 102 can be an application specific integrated circuit (ASIC), a programmable or non-programmable logic device or array, a specially configured general purpose processor, or the like. Moreover, the processor 102 can include peripheral components such as bus interfaces, memories, user interfaces, network interfaces, or the like.

The listing database 104 and the DNC database can be stored in any variety of memory that can store a database. For example, the memory can be a dynamic random access memory. However, other memories can include static random access memories, read-only memories, mass storage devices, network accessed storage, volatile and/or non-volatile memory, other storage devices and their associated storage media, including hard-drives, floppy-disks, optical storage, tapes, flash memory, memory sticks, digital video disks, or the like can be used.

Although an effective date and an expiration date have been used as examples, various other dates can be used as desired. For example, disconnection dates, transfer dates, or any other date associated with ownership of the phone number can be used.

Although particular embodiments have been described, it will be appreciated that the principles of the invention are not limited to those embodiments. Variations and modifications may be made without departing from the principles of the invention as set forth in the following claims.

What is claimed is:

1. A method, comprising:
creating a first set of records associated with a phone number from a database in response to a reference date;
creating a second set of records associated with the phone number from the database in response to the first set of records;
comparing the first set of records to the second set of records; and
updating a status of the phone number in a do-not-call database in response to the comparing of the first set of records to the second set of records.

2. The method of claim 1, wherein creating the first set of records comprises identifying a record of the database in response to the reference date.

3. The method of claim 2, wherein identifying the record of the database comprises identifying a record of the database having a date range including the reference date.

4. The method of claim 3, wherein identifying the record of the database further comprises if the record of the database having the date range including the reference date is not identified, identifying a record of the database having a date range after the reference date.

5. The method of claim 4, wherein creating the second set of records further comprises identifying a gap between an end of the date ranges of the records of the first set and a start of a date range of a subsequent record of the database.

6. The method of claim 2, wherein creating the first set of records further comprises:
adding the identified record to the first set; and
adding records of the database to the first set that include date ranges overlapping a date range of the identified record.

7. The method of claim 6, wherein creating the first set of records further comprises:
adding records of the database to the first set that include date ranges overlapping any date range of any record in the first set.

8. The method of claim 1, wherein creating the second set of records comprises:
determining a next date after date ranges of the records of the first set;
identifying a record of the database having a date range beginning first in time after the next date; and
adding the identified record to the second set.

9. The method of claim 8, wherein creating the second set of records further comprises adding records of the database to the second set that include date ranges overlapping a date range of the identified record.

10. The method of claim 9, wherein creating the second set of records further comprises adding records of the database to the second set that include date ranges overlapping any date range of any record in the second set.

11. The method of claim 1, wherein comparing the first set of records to the second set of records comprises comparing names of the records of the first set with names of the records of the second set.

12. The method of claim 11, wherein comparing the first set of records to the second set of records comprises if a match is found between a name of a record of the first set and a name of a record of the second set, adding the records of the second set to the first set and creating another second set of records in response to the first set of records.

13. The method of claim 12, wherein the match is found if a degree of match between the name of the record of the first set and the name of the record of the second set is greater than or equal to a threshold.

14. The method of claim 11, wherein updating the status of the phone number in a do-not-call database comprises if a match is not found between a name of a record of the first set and a name of a record of the second set, removing the phone number from the do-not-call database.

15. The method of claim 1, wherein updating the status of the phone number in a do-not-call database comprises if the second set is an empty set, leaving the phone number in the do-not-call database.

16. A system, comprising:
a processor coupled to a listing database and a do-not-call database, the processor configured to:
create a first set of records associated with a phone number from the listing database in response to a reference date;
create a second set of records associated with the phone number from the listing database in response to the first set of records;
compare the first set of records to the second set of records; and
update a status of the phone number in the do-not-call database in response to the comparing of the first set of records to the second set of records.

17. The system of claim 16, wherein the processor is further configured to identify a record of the database in response to the reference date.

18. The system of claim 17, wherein the processor is further configured to:
add the identified record to the first set; and
add records of the database to the first set that include date ranges overlapping a date range of the identified record.

19. The system of claim 16, wherein the processor is further configured to:
determine a next date after date ranges of the records of the first set;
identify a record of the database having a date range beginning first in time after the next date; and
adding the identified record to the second set.

20. The system of claim 16, wherein the processor is further configured to compare names of the records of the first set with names of the records of the second set.
